(19) United States
(12) Patent Application Publication
(10) Pub. No.: US 2007/0061377 A1
(43) Pub. Date: Mar. 15, 2007

(54) Document management system and control method thereof

(75) Inventor: Kazuteru Tani, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/515,835

(22) Filed: Sep. 6, 2006

(30) Foreign Application Priority Data
Sep. 9, 2005 (JP) 2005-262982

(51) Int. Cl. G06F 17/30

(52) U.S. Cl. 707/200

(57) ABSTRACT

There is provided a document management system and a control method thereof which can realize a preferred workflow by setting a state of a document stored in a folder and a device control at the change of the state, with respect to the folder. To accomplish this, the document management system stores at least one or more folders which can store the document therein and in which the state of the above described document is previously defined. Next, the document is stored in above described folder. Here, the state of the document stored in the folder is caused to change depending on the state which is previously defined in the above described folder. Moreover, a device in the system is controlled in a previously defined manner corresponding to the state of the document.

### BACKGROUND OF THE INVENTION

1. Field of the Invention

The present invention relates to a document management system and a control method thereof which realize a document-based workflow using a folder.

2. Description of the Related Art

Because of the introduction of IT in every industry and advancement of the Internet environment in recent years, a workflow system grows steadily, which executes a predetermined business process by transmitting documents among a plurality of people(for example, refer to Japanese Patent Laid-Open No. 11-259591).

However, the conventional workflow system includes the server for the workflow system and the plurality of computer terminals which are connected via the network. Thus, it was necessary to prepare a user account and to define and manage a workflow, and a burden on a user for it also becomes large.

Therefore, it was difficult to realize the workflow storing in one folder and sharing the document used by a plurality of users in the same workflow.

### SUMMARY OF THE INVENTION

The present invention is made in consideration of such a situation, and it is an object of the present invention to provide a document management system and a control method thereof which can realize a preferable workflow. In other words, this document management system and the control method thereof realize the preferable workflow by storing in one folder a document used by a plurality of users in the same workflow, and sharing the document among the plurality of users.

According to the present invention, the foregoing object is attained by providing a document management system that manages a document, comprising:

a memory unit adapted to store at least one or more folders which define a state of the document;

a management unit adapted to managing the document stored in the folder based on the state of the document previously defined in the folder; and

a control unit adapted to control a device in the system corresponding to the state of the document.

According to another aspect of the present invention, the foregoing object is attained by providing a control method of a document management system comprising a memory unit adapted to store at least one or more folders which define a state of the document stored therein, the control method comprising the steps of:

storing the document in the folder;

managing the document in the folder based on the state of the document previously defined in the folder; and

controlling a device in the system in a previously defined manner corresponding to the state of the document.

In still another aspect of the present invention, the foregoing object is attained by providing a computer program stored in a computer-readable storage medium, the program causes a document management system comprising a memory unit which stores at least one or more folders and in which a state of the document is defined, to executes the steps of:

storing the document in the folder;

managing the document in the folder based on the state of the document previously defined in the folder; and

controlling a device in the system in a previously defined manner corresponding to the state of the document.

Further features of the present invention will become apparent from the following description of exemplary embodiments with reference to the attached drawings.

### BRIEF DESCRIPTION OF THE DRAWINGS

FIG. 1 is a block diagram showing a hardware configuration of a digital Multiple Function Peripheral (MFP) 200 which realizes a document management system according to an embodiment of the present invention;

FIG. 2 is a diagram showing a relationship between a process module group operating in the MFP 200 and records operated by the module group, in the document management system according to an embodiment of the present invention;

FIG. 3 is a diagram showing a format example of a folder information memory unit 212, a document state memory unit 213 and a device control memory unit 214 of a folder information storage record 211 in the MFP 200;

FIG. 4 is a diagram showing a format example of a document information memory unit 216 and a information memory unit 217 of a document information storage record 215 in the MFP 200;

FIG. 5 is a diagram showing an example of a folder selection screen 500;

FIG. 6 is a diagram showing a display example of a document state setting screen 600;

FIG. 7 is a diagram showing an example of a document state change screen 700;

FIG. 8 is a diagram for illustrating relationships among a folder 801 stored in an HDD 110 of the MFP 200, a document 802 stored in the folder 801, the corresponding folder information storage record 211 and the corresponding document information storage record 215;

FIG. 9 is a flowchart for illustrating a series of processes by the MFP 200 from accepting an instruction for setting the folder information storage record 211 on a screen displayed at an operation unit 101, until storing the setting in the folder information memory unit 212;

FIG. 10 is a flowchart for illustrating a process by the MFP 200 from accepting an input of a new document in the folder, until setting an initial document state name and the like from the folder information storage record bound to the inputted folder;

FIG. 11 is a flowchart for illustrating a series of processes by the MFP 200 from accepting a scan at a scanner 117, until changing a state of the document and executing a device control at the change of the state;

FIG. 12 is a flowchart for illustrating a series of processes by the MFP 200 from accepting a deletion of the document 802 stored in the folder 801, until deleting the document information storage record 215 bound to the document 802;

FIG. 13 is a diagram showing a setting example of a document state order 302, a document state name 303, and a device control 304 of the folder information storage record 211 in an estimation system; and

FIG. 14 is a diagram showing a setting example of the document state order 302, the document state name 303, and the device control 304 of the folder information storage record 211 in a purchase system.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Hereinafter a document management system according to an embodiment of the present invention will be described in detail, with reference to the drawings.

### First Embodiment

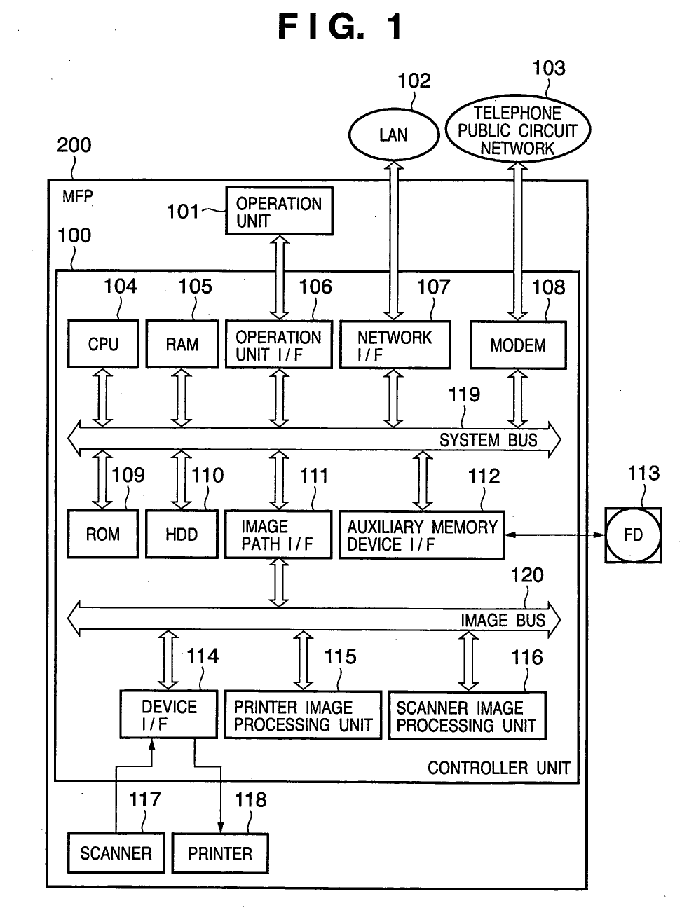

FIG. 1 is a block diagram showing a hardware configuration of a digital MFP (Multiple Function Peripheral) 200 which realizes a document management system according to the first embodiment of the present invention. As shown in FIG. 1, MFP 200 includes a controller unit 100, an operation unit 101, a scanner 117 and a printer 118. Furthermore, the controller unit 100 includes a CPU 104, a RAM 105, an operation unit I/F 106, a network I/F 107, a modem 108, a ROM 109, an HDD 110, and an image path I/F 111. Furthermore, the controller unit 100 includes an auxiliary memory device I/F 112, a device I/F 114, a printer image processing unit 115, a scanner image processing unit 116, a system bus 119 and an image bus 120.

The controller unit 100 connects to the scanner 117 which is an image input device, and the printer 118 which is an image output device. On the other hand, the MFP 200 can exchange image information or data with another information device by connecting to a Local Area Network (LAN) 102 or a telephone public circuit network 103. The CPU 104 is a central arithmetic processing unit which controls the entire system.

The RAM 105 is a system work memory for operation of the CPU 104, and also functions as an image memory for storing image data. The ROM 109 is a read only memory which has stored an operation processing procedure of the CPU 104. In the ROM 109, a program which has recorded basic software (OS) which is a system program for controlling devices of an information processing apparatus, and information required for operating the system and the like have been recorded. Also, instead of the ROM 109, the hard disk drive (HDD) 110 described below may be used. The HDD 110 is used for saving an application program, the image data or various data. The application program in this embodiment is a software module (module) and the like for executing various processing units in this embodiment.

The auxiliary memory device I/F 112 takes charge of an interface with an auxiliary memory device. For example, the auxiliary memory device I/F 112 inputs and outputs with respect to a removable disk such as a floppy (registered trademark) disk drive, a CD-ROM drive and the like. In other words, the auxiliary memory device I/F 112 is used for reading and writing the above described application program from media, and the like.

An FD 113 is a removable data recording device (removable medium) which is read or written by the auxiliary memory device I/F 112. For example, as the FD 113, there are a magnetic recording medium (for example, a floppy (registered trademark) disk or an external hard disk), an optical recording medium (for example, a CD-ROM), a magneto optical recording medium (for example, an MO), a semiconductor recording medium (for example, a memory card) and the like. It should be noted that the application program or the data to be stored in the HDD 110 may also be stored and used in the FD 113.

The operation unit I/F 106 takes charge of an interface with the operation unit 101, and outputs the image data to be displayed on the operation unit 101 with respect to the operation unit 101. Moreover, the operation unit I/F 106 functions to communicate information inputted by a user of the MFP 200 through the operation unit 101, to the CPU 104. The network I/F 107 connects to the LAN 102, and inputs and outputs information with respect to another information device connected to the LAN 102. The modem 108 connects to the telephone public circuit network 103, and inputs and outputs information with respect to another information device connected to the telephone public circuit network 103. The image path I/F 111 is a bus bridge which connects the system bus 119 and the image bus 120 for transferring the image data at high speed.

The scanner 117 is the image input (image reading) device which reads the image from a manuscript. The printer 118 is the image output (image formation) device which forms the image on a paper sheet.

The image bus 120 is a bus which is compliant with a PCI-Express standard, for example. At the image bus 120, the following devices are arranged. First, the device I/F 114 connects the scanner 117 which is the image input device and the printer 118 which is the image output device with the controller unit 100, and controls them. The scanner image processing unit 116 corrects, processes and edits the image data inputted from the scanner 117. The printer image processing unit 115 performs a correction, a resolution conversion and the like, with respect to print output image data to the printer 118.

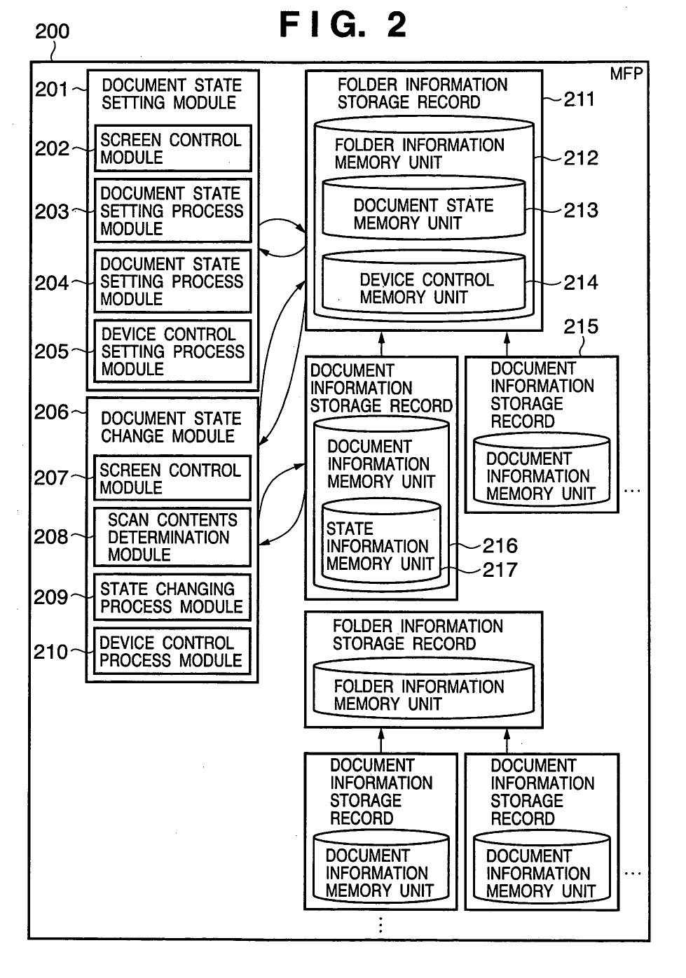

FIG. 2 is a diagram showing a relationship between a process module group operating in the MFP 200 and records operated by the module group, in the document management system according to an embodiment of the present invention. In FIG. 2, reference numerals 201 and 206 denote process modules respectively, specifically, a document state setting module and a document state change module. The process module group is read from the ROM 109, the HDD 110 or the FD 113 shown in FIG. 1, and expanded into the RAM 105. The CPU 104 operates according to descriptions of these process modules.

In FIG. 2, a folder information storage record 211 and a document information storage record 215 are stored in the HDD 110, the RAM 105, the FD 113 or the like in the MFP 200, by using a file system or a database system. Arrows shown in FIG. 2 denote main controls or information flows between the process module group and the records.

The process module group is automatically launched, or through the operation unit I/F 106 according to the information or an instruction inputted by an operator from the operation unit 101, expanded into the RAM 105 if necessary and communicated to the CPU 104. If necessary, an arithmetic result at the CPU 104 is displayed at the operation unit 101 as result information via the operation unit I/F 106. Transmission among the CPU 104, the RAM 105, the ROM 109, the network I/F 107, the operation I/F 106, the HDD 110 and the auxiliary memory device I/F 112 is performed through the system bus 119.

Inputting the information or the instruction, and display of the arithmetic result information may be performed at a network browsing unit (for example, a browser and the like) connected to the LAN 102 via the network I/F.

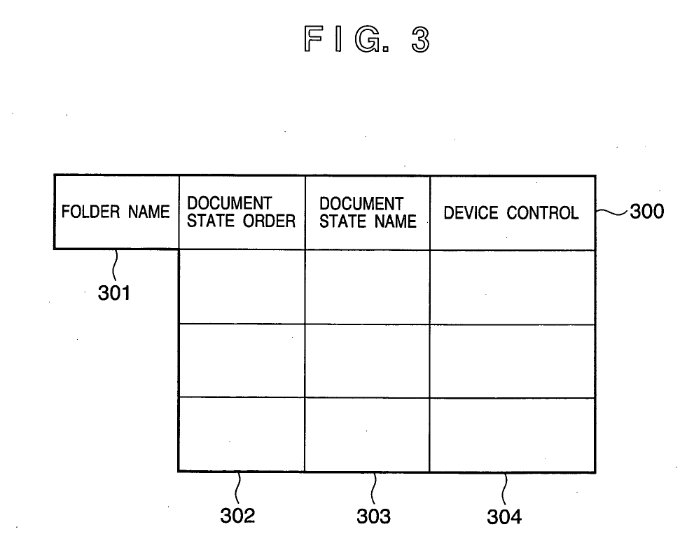

FIG. 3 is a diagram showing a format example of a folder information memory unit 212, a document state memory unit 213 and a device control memory unit 214 of the folder information storage record 211 in the MFP 200. A folder information record 300 is configured with a folder name 301 for identifying a folder, a document state order 302, a document state name 303, a device control 304 and the like.

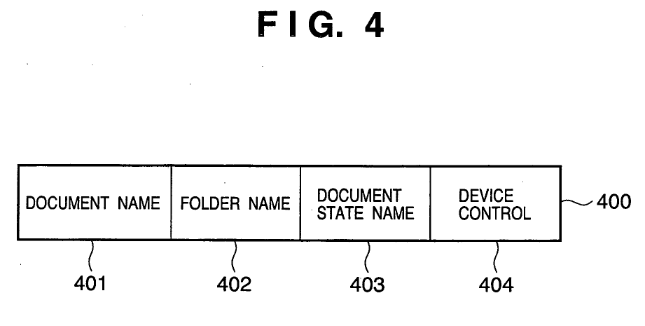

FIG. 4 is a diagram showing a format example of a document information memory unit 216 and a state information memory unit 217 of the document information storage record 215 in the MFP 200. A document information record 400 is configured with a document name 401 for identifying a document, a folder name 402 for identifying the folder, a document state name 403, a device control 404 set to be executed at the change of the state (for example, not editable, unprintable or the like) and the like.

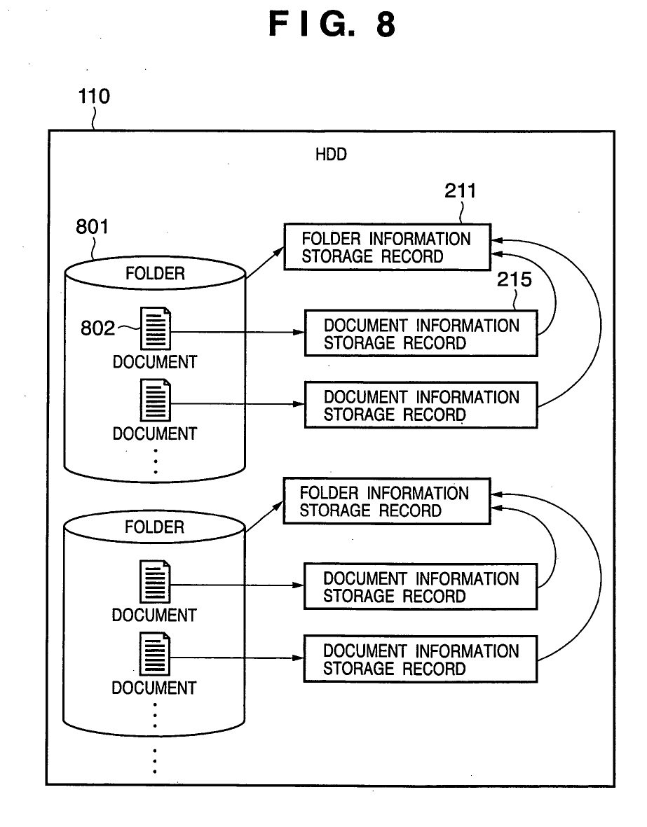

FIG. 8 is a diagram for illustrating relationships among a folder 801 stored in the HDD 110 of the MFP 200, a document 802 stored in the folder 801, the corresponding folder information storage record 211 and the corresponding document information storage record 215. In FIG. 8, in the HDD 110, one or more folders 801 are stored. Also, in the folder 801, zero or more documents 802 are stored. Each folder 801 has one folder information storage record 211. Also, the document 802 has one document information storage record 215.

Each document information storage record 215 is bound to (associated with) a certain folder information storage record 211. Also, the document information storage record 215, which is bound to the document 802 stored in the same folder 801, is bound to the folder information storage record 211 bound to the folder 801.

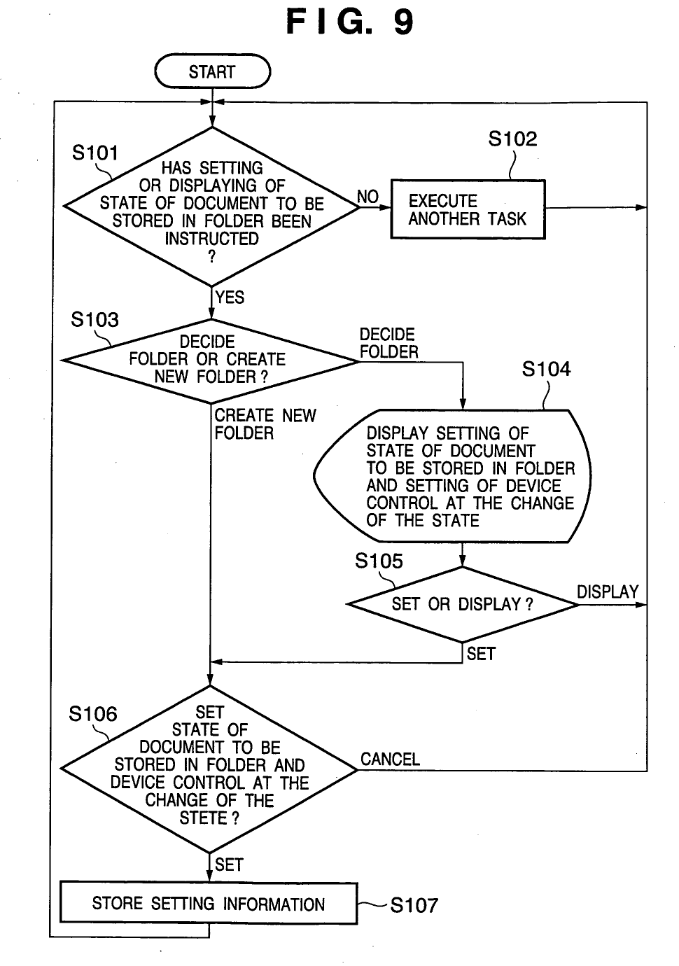

Hereinafter outlines of the respective processes will be described in sequence by using flowcharts shown in FIGS. 9, 10, 11 and 12.

FIG. 9 is a flowchart for illustrating a series of processes by the MFP 200 from accepting an instruction for setting the folder information storage record 211 on a screen displayed at the operation unit 101, until storing the setting in the folder information memory unit 212. In other words, a process will be described in which the MFP 200 accepts the instruction for setting a state of the document, and with respect to a folder set by the user, stores setting information on the state of the document to be stored in the folder, in the folder information memory unit 212 of the folder information storage record 211.

First, it is determined whether or not the setting or the displaying of the state of the document to be stored in the folder are instructed by the operation unit 101 (step S101). This determination is performed according to the document state setting module 201, which is the program read from the program ROM 109 into the RAM 105 in the MFP 200 to be available.

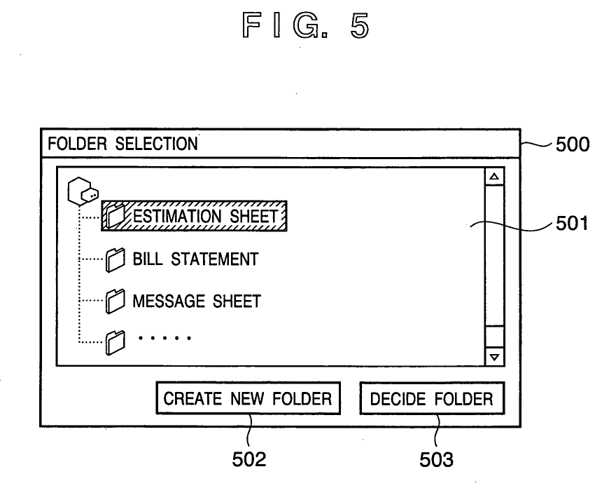

As the result, if the setting or the displaying is not instructed (No), another task instructed is executed (step S102), and the process returns to step S101. On the other hand, if the setting or the displaying if instructed at step S101 (Yes), it is determined whether a “decide folder” button 503 or a “create new folder” button 502 is depressed (step S103). The above described determination is performed according to a screen control module 202 of the document state setting module 201, which is the program read from the program ROM 109 into the RAM 105 in the MFP 200 to be available. Also, the above described determination is performed in a state where a folder selection screen image 500 is displayed on the operation unit 101, and a folder is selected from a folder list 501 in which the folder information storage record 211 is set with respect to the folder 801. FIG. 5 is a diagram showing an example of the folder selection screen 500.

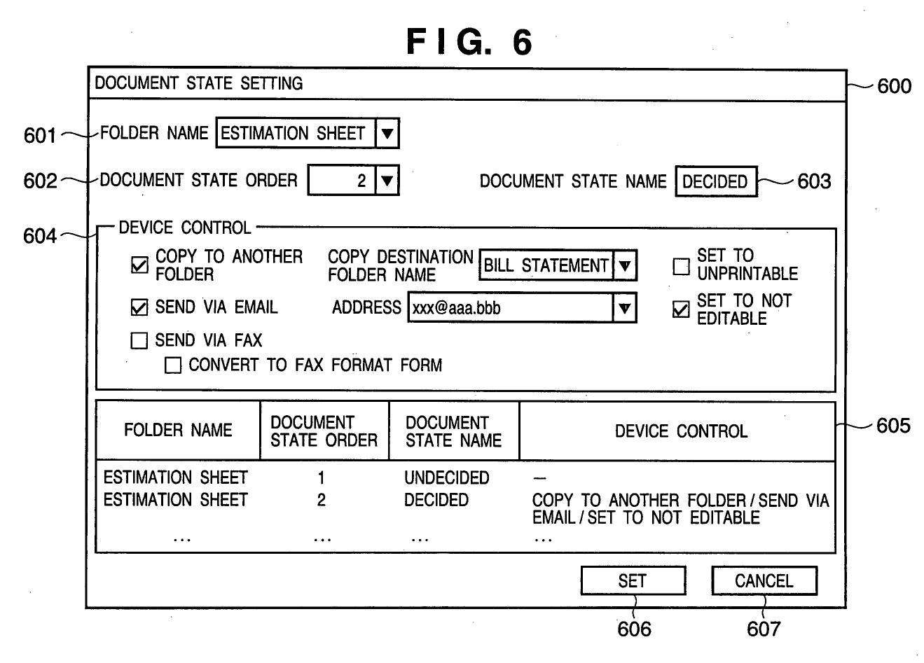

At step S103, if the “decide folder” button 503 is depressed, the setting of the state of the document to be stored in the folder, and the setting of the device control to be executed at the change of the state are displayed (step S104). The above described process is performed according to the screen control module 202 of the document state setting module 201, which is the program read from the program ROM 109 into the RAM 105 in the MFP 200 to be available. Specifically, on the operation unit 101, a selected folder name 601, a document state order set in the folder 602, and a document state name 603 are displayed. Furthermore, on the operation unit 101, the folder information storage record 211 of a device control 604, such as “copy to another folder”, “send via email”, “send via FAX”, “set to unprintable”, “set to not editable” and the like, is displayed. FIG. 6 is a diagram showing a display example of a document state setting screen 600.

After the settings are displayed at step S104, it is determined whether “setting” or “displaying” is instructed at step S101 (step S105). As the result, if “display” is instructed, the process returns to step S101.

On the other hand, if the “create new folder” button 502 is depressed at step S103, or at step S105, if it is determined that the “setting” is instructed at step S101, the process proceeds to step S106. At step S106, the document state setting screen image 600 is displayed on the operation unit 101, and the setting of the device control 604 is accepted. Specifically, the folder name 601, the document state order 602, the document state name 603, “copy to another folder”, “send via email”, “send via FAX”, “set to unprintable”, “set to not editable” and the like are set. It should be noted that the above described process is performed according to the screen control module 202 of the document state setting module 201, which is the program read from the program ROM 109 into the RAM 105 in the MFP 200 to be available.

As the result, if a “set” button is depressed at step S106, the setting information is stored (step S107), and the process returns to step S101. Specifically, the document state order 602 and the document state name 603 which are bound to the folder name 601 are stored in the document state memory unit 213 of the folder information storage record 211. The above described process is performed according to a document state setting process module 204 of the document state setting module 201, which is the program read from the program ROM 109 into the RAM 105 in the MFP 200 to be available. Also, according to a device control setting process module 205, the device control 604 bound to the folder name 601 is stored in the device control memory unit 214 of the folder information storage record 211. It should be noted that there are “copy to another folder”, “send via email”, “send via FAX”, “set to unprintable”, “set to not editable” and the like in the device control 604.

On the other hand, if a “cancel” button 607 is depressed at step S106, the process returns to steps S101. The above described process is according to the document state setting module 201, which is the program read from the program ROM 109 into the RAM 105 in the MFP 200 to be available.

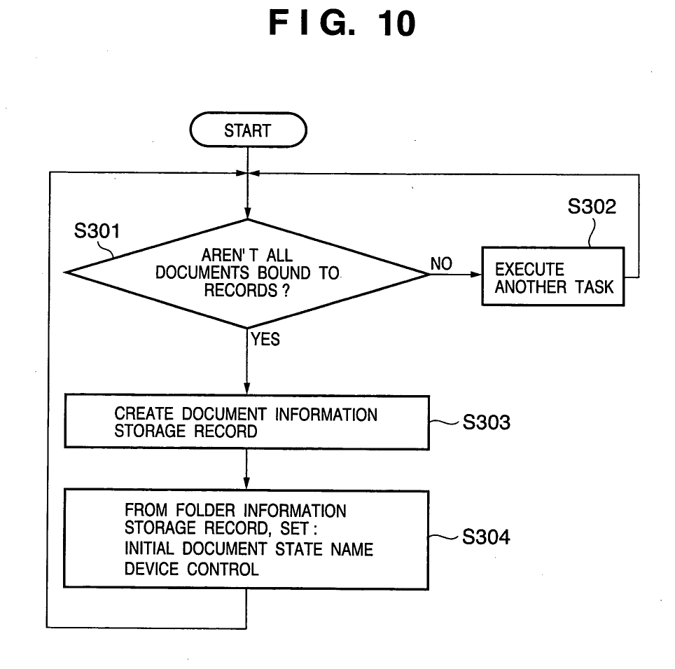

FIG. 10 is a flowchart for illustrating a process by the MFP 200 from accepting an input of a new document in the folder, until setting an initial document state name and the like from the folder information storage record bound to the inputted folder. In other words, when the input of the new document into the folder is accepted, the document information storage record is created. Next, from the folder information storage record 211 bound to the inputted folder, the initial document state name and the device control are set.

First, it is determined whether or not the document information storage record 215 bound to the document 802 inputted into the folder 801 exists (step S301). The above described process is according to the document state change module 206, which is the program read from the program ROM 109 into the RAM 105 in the MFP 200 to be available.

As the result, if it is determined to be NO at step S301, another task which is instructed (for example, step S201, step S401 or the like) is executed (step S302), and the process returns to step S301.

On the other hand, if it is determined to be YES at step S301, the document information storage record 215 is created (step S303). The above described process is according to the document state change module 206, which is the program read from the program ROM 109 into the RAM 105 in the MFP 200 to be available. Next, at step S304, from the folder information storage record 211 bound to the inputted folder 801, the folder name, the initial document state name and the device control are set. The process returns to step S301.

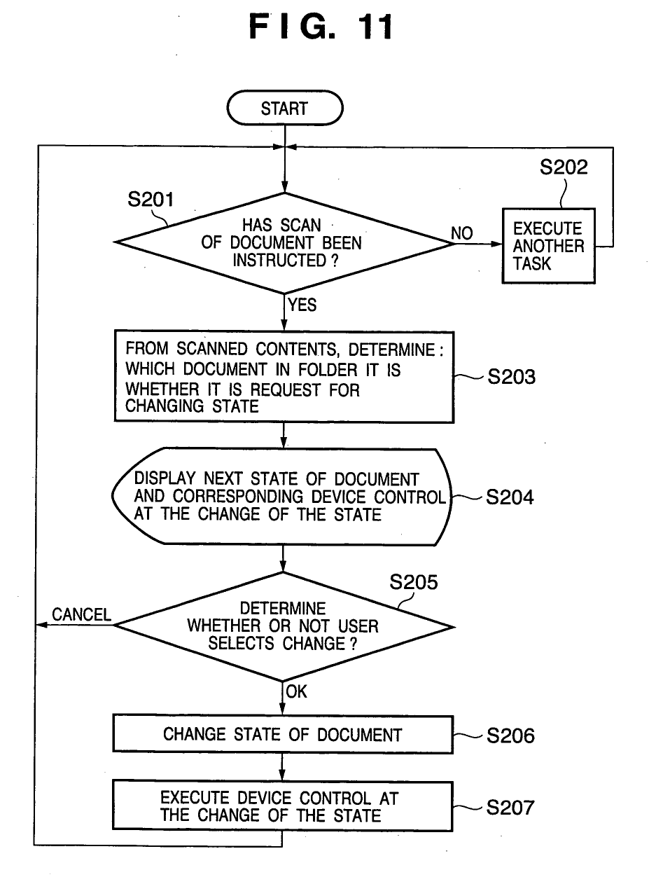

FIG. 11 is a flowchart for illustrating a series of processes by the MFP 200 from accepting a scan at the scanner 117, until changing the state of the document and executing the device control at the change of the state.

First, it is determined whether or not the scan of the document is instructed (step S201). If it is determined to be NO at step S201, another task which is instructed (for example, step S301, step S401 or the like) is executed (step S202), and the process returns to step S201.

On the other hand, if it is determined to be YES at step S201, it is determined whether or not a scanned document is related to the document in the folder, and whether or not the scanned document instructs the state change (step S203), from image data contents of the scanner image processing unit 116. It should be noted that the above described process is according to a scan contents determination module 208 of the document state change module 206, which is the program read from the program ROM 109 into the RAM 105 in the MFP 200 to be available. Here, the determination whether or not the scanned document is related to the document 802 in the folder 801, from the image data contents, is based on the contents in which a watermark, a tint block, a two-dimensional barcode (QR code) and the like, which have been printed on the scanned document, have been analyzed. Also the same applies to the determination whether or not the scanned document instructs the state change.

At step S203, if it is determined that the above described document is the document 802 in the folder 801 and is the document which requests the change of the state, the process proceeds to step S204. At step S204, the current document state name 403 bound to the document name 401 is obtained from the document information storage record 215. It should be noted that the above described process is according to a screen control module 207 of the document state change module 206, which is the program read from the program ROM 109 into the RAM 105 in the MFP 200 to be available.

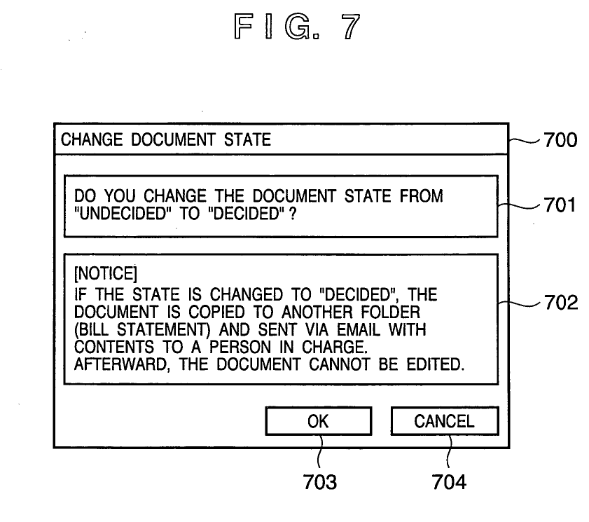

At step S204, the state to which the document changes next is obtained from the document state name 303 in the folder information storage record 211, using the folder name 402 and the obtained current document state name 403. Furthermore, the device control to be executed at the next change of the state, is obtained from the device control 304 of the folder information storage record 211, using the obtained next document state name 303. Each obtained data is displayed as a state 701 to which the document changes next and a device control 702 to be executed at the next change of the state. FIG. 7 is a diagram showing an example of a document state change screen 700.

Next, at step S205, it is determined whether an “OK” button 703 or a “cancel” button 704 is depressed. If the “cancel” button 704 is depressed, the process returns to step S201.

On the other hand, at step S205, if it is determined that the “OK” button 703 is depressed, the current document state name 403 bound to the document name 401 is obtained from the document information storage record 215 (step S206). It should be noted that the above described process is according to a state change process module 209 of the document state change module 206, which is the program read from the program ROM 109 into the RAM 105 in the MFP 200 to be available.

At step S206, the next state of the document is obtained from the document state name 303 in the folder information storage record 211, using the folder name 402 and the obtained current document state name 403. Furthermore, the device control to be executed at the next change of the state, is obtained from the device control 304 in the folder information storage record 211, with the obtained document state name 303 which represents the next state of the document. Moreover, the document state name, which is linked to the document name and stored in the state information memory unit 217 of the document information storage record 215, is changed to the next document state name.

Next, the device control obtained at step S206 is executed (step S207), and the process returns to step S201. It should be noted that the above described process is according to a device control process module 210 of the document state change module 206, which is the program read from the program ROM 109 into the RAM 105 in the MFP 200 to be available.

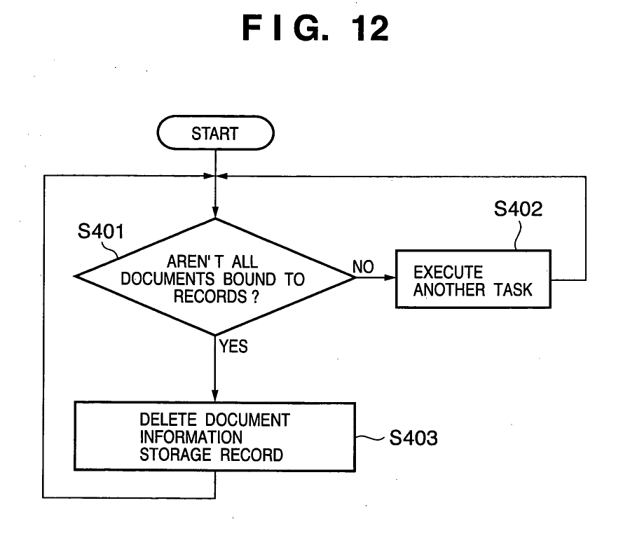

FIG. 12 is a flowchart for illustrating a series of processes by the MFP 200 from accepting a deletion of the document 802 stored in the folder 801, until deleting the document information storage record 215 bound to the document 802.

First, at step S401, it is determined whether or not the document information storage record 215 which is not bound to the document 802 stored in the folder 801 exists. The above described process is according to the document state change module 206, which is the program read from the program ROM 109 into the RAM 105 in the MFP 200 to be available.

As the result, if it is determined to be NO at step S401, another task which is instructed (for example, step S201, step S301 or the like) is executed (step S402), and the process returns to step S401. On the other hand, if it is determined to be YES at step S401, the document information storage record 215 bound to the document 802 is deleted (step S403), and the process returns to step S401. It should be noted that the above described process is according to the document state change module 206, which is the program read from the program ROM 109 into the RAM 105 in the MFP 200 to be available.

### Second Embodiment

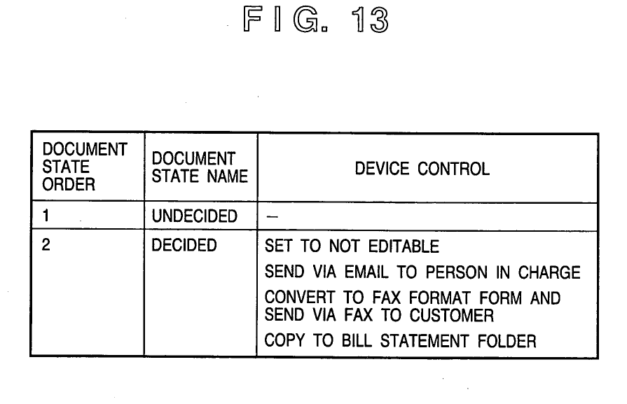

The second embodiment uses the above described system of the first embodiment as an estimation system. FIG. 13 is a diagram showing a setting example of the document state order 302, the document state name 303, and the device control 304 of the folder information storage record 211 in the estimation system.

### Third Embodiment

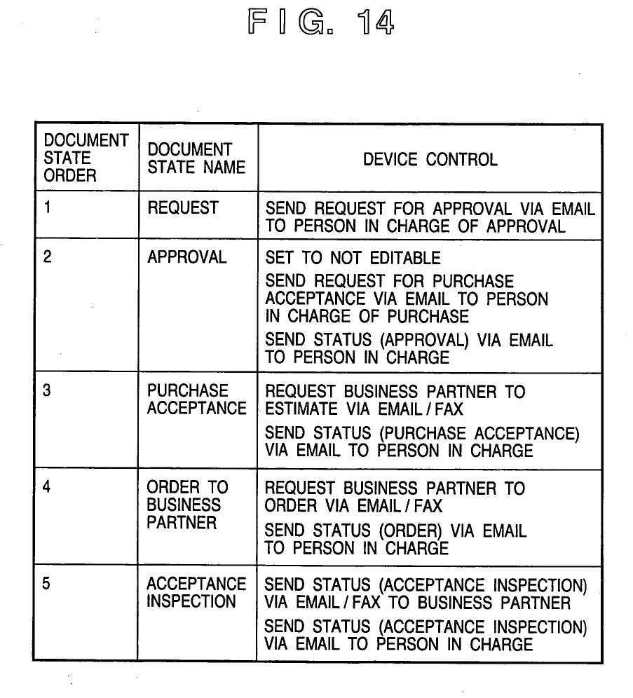

The third embodiment uses the above described system of the first embodiment as a purchase system. FIG. 14 is a diagram showing a setting example of the document state order 302, the document state name 303, and the device control 304 of the folder information storage record 211 in the purchase system.

### Other Embodiments

The followings can be applied to the above described system as the device controls:

encryption of the document;

composition of the document;

movement of the document;

deletion of the document;

conversion of a file format form (PDF); and

sending to a previously connected server.

In the first embodiment, it is explained that when it is requested to change the state of the document 802 stored in the folder 801 on scanning, the state of the document changes to the next state. The following processes can be used as the trigger of the change of the state:

receiving an email;

receiving a FAX;

storage of the document in another folder;, instruction with the user's command; and

time.

The embodiments described above are able to be combined each other as any type of combination.

The present invention can take implementations such as a system, an apparatus, a method, a program, a storage medium (recording medium) or the like. Specifically, the present invention may be applied to a system configured with a plurality of devices, or applied to an apparatus consisting of one device.

It should be noted that the present invention is also achieved by supplying a software program (in the embodiments, programs corresponding to the flowcharts shown in the drawings) for realizing the functions of the above described embodiments to the system or the apparatus directly or remotely, and reading and executing the above described supplied program codes by a computer of the system or the apparatus.

Therefore, also the program codes themselves, which are installed in the above described computer in order to realize functional processing of the present invention in the computer, realize the present invention. In other words, the present invention also includes a computer program itself for realizing the functional processing of the present invention.

In that case, the present invention may take any form such as an object code, a program executed by an interpreter, script data supplied to the OS or the like, as long as it has a program function.

As the recording medium for supplying the program, for example, there are media such as the floppy (registered trademark) disk, the hard disk, an optical disk, an magneto optical disk, the MO, the CD-ROM, a CD-R, a CD-RW, a magnetic tape, a nonvolatile memory card, a ROM, a DVD (DVD-ROM and DVD-R).

As another method of supplying the program, it is also possible to supply the program by using the browser of a client computer to download the program from a homepage on the Internet to the recording medium such as the hard disk and the like. In other words, after the client computer connects to the homepage, the computer program itself of the present invention or a compressed file thereof containing an automatic installation function is downloaded from the above described homepage. Also, the method of supplying the program may be realized by dividing the program code constituting the program of the present invention into a plurality of files, and downloading the respective files from different homepages. In other words, a WWW server, which allows a plurality of users to download the program files for realizing the functional processing of the present invention by the computer, is also included in the present invention.

Moreover, the present invention can also be realized as follows. The program of the present invention is encrypted, stored in the storage medium such as the CD-ROM and the like, and distributed to the user. A user who has satisfied a predetermined condition is caused to download decryption key information from the homepage via the Internet. The user executes the encrypted program by using the key information, and installs the program in the computer.

Moreover, the functions of the above-described embodiments are realized by executing the read program by the computer. In addition, based on the instructions of the program, the functions of the above-described embodiments can also be realized when the OS or the like running on the computer performs part or all of actual processes.

Furthermore, the functions of the above-described embodiments are also realized after the program read from the recording medium is written in a function expansion board inserted into the computer or the memory provided on a function expansion unit connected to the computer. In other words, based on the instructions of the program, the functions of the above-described embodiments are also realized when the CPU or the like provided on the function expansion board or the function expansion unit performs part or all of the actual processes.

According to the present invention, for example, it is possible to realize a preferred workflow by storing a document used by a plurality of users in the same workflow, in one folder, and sharing the document among the plurality of users. In this case, it is possible to realize a document-based workflow using a folder in a memory device retained by the system such as the MFP and the like, without conventionally introducing a workflow system. Therefore, it is unnecessary to separately prepare a server for the workflow system, a plurality of computer terminals, user accounts and the like.

Furthermore, it becomes possible to realize the workflow, with various device control methods which can be performed by the MFP and the like, and all or a partial combination of the triggers of requesting the change of the state which can be accepted by the MFP.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-262982 filed on Sep. 9, 2005, which is hereby incorporated by reference herein in its entirety.

What is claimed is:

1. A document management system that manages a document, comprising:
a memory unit adapted to store at least one or more folders which define a state of the document;
a management unit adapted to managing the document stored in the folder based on the state of the document previously defined in the folder; and
a control unit adapted to control a device in the system corresponding to the state of the document.

2. The system according to claim 1, further comprising a display unit adapted to display a state to which the document stored in the folder may change next, and information related to the device control corresponding to the state.

3. The document management system according to claim 1, further comprising:
a reading unit adapted to read the document;
a determination unit adapted to determine a next state to which the document changes, by reading another document which requests the change of the state; and
a present unit adapted to present the next state to a user.

4. The document management system according to claim 3, wherein said document management system is implemented on a digital multiple function peripheral provided with a function of reading the document.

5. The document management system according to claim 4, wherein a state to which the document stored in the folder may change next, and information related to the device control corresponding to the state, which are stored in a memory device retained by the digital multiple function peripheral, are displayed on a GUI screen of the digital multiple function peripheral, and the user is caused to decide them on said GUI screen.

6. The document management system according to claim 1, further comprising a setting unit adapted to set the state of the document stored in the folder and the device control corresponding to the state.

7. The document management system according to claim 6, wherein said setting unit displays setting options of the state of the document stored in the folder and the device control corresponding to the state, on a GUI screen, and causes the user to change the setting via said GUI screen.

8. The document management system according to claim 1, wherein the device control is any one of copying to another folder, movement to another folder, deletion, sending via an email, sending via a FAX, sending to a previously connected server, setting to unprintable, setting to not editable, encryption, composition, or conversion of a file format form.

9. The document management system according to claim 1, wherein the document is stored in the folder by at least one of reading the original, receiving an email, receiving a FAX, storing the document in another folder, an instruction with a user's command, or an operation according to a time.

10. The document management system according to claim 1, wherein said document management system is operated as an estimation system.

11. The document management system according to claim 1, wherein said document management system is operated as a purchase system.

12. A control method of a document management system comprising a memory unit adapted to store at least one or more folders which define a state of the document stored therein, said control method comprising the steps of:
storing the document in the folder;
managing the document in the folder based on the state of the document previously defined in the folder; and
controlling a device in the system in a previously defined manner corresponding to the state of the document.

13. A computer program stored in a computer-readable storage medium, the program causes a document management system comprising a memory unit which stores at least one or more folders and in which a state of the document is defined, to executes the steps of:
storing the document in the folder;
managing the document in the folder based on the state of the document previously defined in the folder; and
controlling a device in the system in a previously defined manner corresponding to the state of the document.
